(19) United States
(12) Patent Application Publication
(10) Pub. No.: US 2004/0229539 A1
(43) Pub. Date: Nov. 18, 2004

(54) Plasma deposited amorphous silicon nitride interlayer enabling polymer lamination to germanium

(75) Inventors: James Neil Johnson, Schenectady, NY (US); Kevin Warner Flanagan, Albany, NY (US); David Corbin Burton, Lady Lake, FL (US)

Correspondence Address: SCULLY SCOTT MURPHY & PRESSER, PC, 400 GARDEN CITY PLAZA, GARDEN CITY, NY, 11530

(73) Assignee: Lockheed Martin Corporation, Bethesda, MD

(21) Appl. No.: 10/436,302

(22) Filed: May 12, 2003

(51) Int. Cl. B32B 15/04

(52) U.S. Cl. 442/290; 442/398; 428/448; 428/450; 428/451; 428/458; 428/480; 428/698; 428/704; 427/164; 156/81; 156/242

(57) ABSTRACT

An optical component and method for manufacturing the comprising is disclosed that comprises an IR transmissive substrate. The substrate is coated with an IR transmissive adhesive, comprising hydrogenated amorphous silicon nitride film (a-SiN:H). The adhesive is coated with a top laminate, whereby the optical component obtains a predetermined shape.

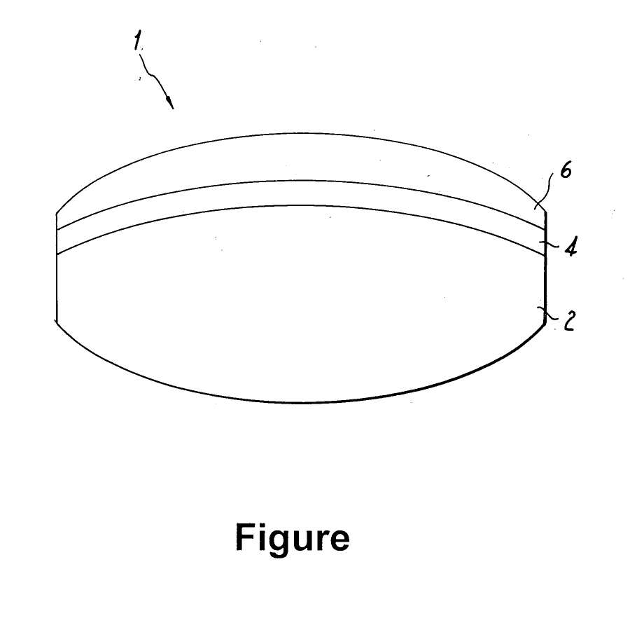

### FIELD OF THE INVENTION

The present invention relates to the field of optics and more specifically to a germanium lens having a polyethylene coating.

### BACKGROUND

The long-wave infrared region is the largest continuous IR transmittance window in the Earth's atmosphere. Military aircraft, for example, use the IR communication window via known communication devices having IR sensors. One of the components involved in IR sensors is a primary lens.

An IR primary lens is an IR transmissive structure. An IR transmissive structure transmits IR energy of wavelengths between about 0.1 microns and 20 microns, preferably between 1 and 15 microns, and most preferably between 2 and 12 microns. A lens is IR transmissive if greater than about 75% of IR transmission occurs. One material that exhibits these characteristics and is commonly used as an IR lens is germanium. Germanium is a favorable material because it has a singular, or binary crystalline structure that is essentially transparent in the IR spectrum.

The shape of the IR primary lens is typically aspheric. The parabolic shape of an aspheric lens is ideal for manipulating the focal point of the IR energy waves. Aspheric germanium lenses are normally manufactured by diamond point turning, a very costly and time consuming process.

In comparison with an aspheric lens, a spherical lens is less expensive to manufacture. However, a spherical lens has a comparably lesser quality image due to chromatic irregularities associated with spherical surfaces. The image quality of a spherical lens can be significantly improved when the lens is coated with a film that can be shaped to mimic the parabolic contours of an aspheric lens. A material that is IR transmissive and has proven industrial coating applications is polyethylene. Unfortunately, polyethylene does not adhere to a germanium substrate.

### SUMMARY

An objective of the invention is to provide a spherical lens having a germanium substrate and a polyethylene coating, where the coating shape mimics an aspheric shape. According to this objective, an optical component and method for manufacturing the comprising is disclosed that comprises an IR transmissive substrate. The substrate is coated with an IR transmissive adhesive, comprising hydrogenated amorphous silicon nitride film (a-SiN:H). The adhesive is coated with a top laminate, whereby the optical component obtains a predetermined shape.

### BRIEF DESCRIPTION OF THE DRAWING

In order that the manner in which the above-recited and other advantages of the invention are obtained, a more particular description of the invention briefly described above will be rendered by reference to specific embodiments thereof which are illustrated in the appended drawing. Understanding that this drawing depicts only a typical embodiment of the invention and is not therefore to be considered to be limiting of its scope, the invention will be described and explained with additional specificity and detail through the use of the accompanying drawing in which:

The FIGURE is a front view of the components of the invention.

### DETAILED DESCRIPTION OF THE INVENTION

Reference will now be made to the drawing. It is to be understood that the drawing is a diagrammatic representation of the embodiment of the present invention and is not drawn to scale.

Turning to the FIGURE, there is illustrated IR lens 1. IR lens 1 comprises wafer 2 that, for purposes of illustration, has a convex shape. One skilled in the art would understand that a lens within the scope of the invention is not limited by thickness, can be a converging lens, a diverging lens, or any combination thereof. Wafer 2 can be any size to accommodate the appropriate IR application.

Wafer 2 is a germanium substrate, or core, manufactured in a method known in the art. For example, wafer 2 is melt formed and cast or slumped into most any size or shape. Wafer 2 maybe cleaned for subsequent processing via an argon etching process, known in the art.

Adhesive coating 4 covers wafer 2. Coating 4 consists of hydrogenated amorphous silicon nitride (a-SiN:H). Coating 4 is the reaction product of plasma enhanced chemical vapor deposition (PECVD), known in the art. PECVD is based on the decomposition of a reagent, in this case SiH₄, near the surface of wafer 2. As compared with other deposition processes, PECVD can successfully occur at low temperatures (see below). PECVD provides the amorphous characteristic of coating 4 that is highly malleable as compared to a crystalline structure that results from other deposition processes. PECVD also requires no curing time and produces highly uniform characteristics as compared to, for example, a bath deposition process.

According to the invention, PECVD occurs within a specific low temperature range, dictated by wafer 2. Heating wafer 2 above 50 degrees Celsius is required to increase the bonding characteristics between wafer 2 and coating 4. However, heating wafer 2 beyond 100 degrees Celsius permanently increases the intrinsic stress of wafer 2. Preferably, PECVD occurs at 55 degrees Celsius.

The thickness of coating 4 is independent of the size of wafer 2. The thickness of coating 4 is at least 50 nanometers to insure adhesion for subsequent processing and at most 100 nanometers to minimize stress. Preferably, the thickness of coating 4 is 50 nanometers.

Top layer of polyethylene 6 covers IR lens 1 and laminates adhesive coating 4. The process for laminating top layer 6 to IR lens 1, known in the art, requires heating solid polyethylene above 100 degrees Celsius, past the glass transition stage, so that the polyethylene can be shaped without tearing. On the other hand, the lamination process requires heating below 200 degrees Celsius, to prevent burning the polyethylene. Preferably the lamination process occurs at 170 degrees Celsius.

During the lamination process, top layer 6 is shaped, in a method known in the art, to provide an aspheric form, defined by parabolic curvature, to IR lens 1. The thickness of top layer 6 is dependent on the specific application of IR lens 1, and readily configurable by one skilled in the art.

Depositing an interlayer of amorphous silicon nitride enables a consistently improved adhesion of polyethylene over a germanium substrate. The adhesive benefit is appreciable when compared to non-coated germanium substrates and germanium substrates coated with other films, such as amorphous GeC:H, diamond like carbon (DLC), and amorphous Si:H. Although amorphous Si:H produces marginally improved adhesion over bare germanium, the addition of Nitrogen in the process produces far superior adhesion.

The polyethylene laminate on a lens comprising a spherical germanium wafer enables the manufacturing of an IR lens with an aspheric shape. A lens comprising a spherical germanium substrate used in place of an aspheric substrate greatly reduces the time and cost of manufacturing the lens, making IR communication systems more affordable. Such a structure, as applied to an IR lens, provides high quality IR communications that are comparable with aspheric germanium lenses.

The present invention may be embodied in other specific forms without departing from its spirit or essential characteristics. The described embodiments are to be considered in all respects only as illustrated and not restrictive. The scope of the invention is, therefore, indicated by the appended claims and their combination in whole or in part rather than by the foregoing description. All changes that come within the meaning and range of equivalency of the claims are to be embraced within their scope.

1) An optical component comprising:
an IR transmissive substrate;
an IR transmissive adhesive coating the substrate, the adhesive comprising hydrogenated amorphous silicon nitride film (a-SiN:H); and
a polymer top laminate, on the adhesive.

2) The optical component of claim 1, wherein the substrate is germanium.

3) The optical component of claim 2, wherein the substrate is spherical.

4) The optical component of claim 2, wherein the thickness of the adhesive coating is between 50 nanometers and 100 nanometers.

5) The optical component of claim 4, wherein the thickness of the adhesive coating is 50 nanometers.

6) The optical component of claim 5, wherein the top laminate is polyethylene having a parabolic surface contour.

7) The optical component of claim 3, wherein the thickness of the adhesive coating is between 50 nanometers and 100 nanometers.

8) The optical component of claim 7, wherein the thickness of the adhesive coating is 50 nanometers.

9) The optical component of claim 8, wherein the top laminate is polyethylene having a parabolic surface contour.

10) A method of making an optical component comprising:
providing an IR transmissive substrate;
depositing an IR transmissive adhesive onto the IR substrate, the adhesive comprising hydrogenated amorphous silicon nitride (a-SiN:H);
depositing a polymer top laminate on the adhesive.

11) The method of claim 10, wherein the step of providing the IR transmissive substrate comprises melt forming, casting or slumping germanium into a predefined shape.

12) The method of claim 11, wherein the step of depositing the adhesive coating comprises plasma enhanced chemical vapor deposition (PECVD), wherein the deposition temperature is between 50 and 100 degrees Celsius.

13) The method of claim 12, wherein the PECVD temperature is 55 degrees Celsius.

14) The method of claim 13, wherein the PECVD process includes depositing the a-SiN:H so that the a-SiN:H has a thickness of between 50 and 100 nanometers.

15) The method of claim 14, wherein the PECVD process includes depositing the a-SiN:H so that the a-SiN:H has a thickness of 50 nanometers.

16) The method of claim 15, wherein the step of depositing the top laminate includes heating polyethylene to between 100 and 200 degrees Celsius and depositing the polyethylene onto the adhesive layer.

17) The method of claim 16, wherein the temperature for heating the polyethylene is 170 degrees Celsius.

18) The method of claim 17, including shaping the polyethylene so that the surface of the polyethylene has a parabolic contour.

19) An article of manufacture comprising:
a germanium core;
an adhesive coating the core, the adhesive comprising hydrogenated amorphous silicon nitride film (a-SiN:H); and
a polymer top laminate, on the adhesive.

20) The optical component of claim 19, wherein the core is spherical.

21) The optical component of claim 19, wherein the thickness of the adhesive coating is between 50 nanometers and 100 nanometers.

22) The optical component of claim 21, wherein the thickness of the adhesive coating is 50 nanometers.

23) The optical component of claim 22 wherein the top laminate is polyethylene having a parabolic surface contour.

24) The optical component of claim 20, wherein the thickness of the adhesive coating is between 50 nanometers and 100 nanometers.

25) The optical component of claim 24, wherein the thickness of the adhesive coating is 50 nanometers.

26) The optical component of claim 25, wherein the top laminate is polyethylene having a parabolic surface contour.

27) A method of making an optical component comprising:
providing a germanium core;
depositing an adhesive onto the IR core, said adhesive comprising hydrogenated amorphous silicon nitride (a-SiN:H);
depositing a polymer top laminate on the adhesive.

28) The method of claim 27, wherein the step of providing the core comprises melt forming, casting or slumping germanium into a predefined shape.

29) The method of claim 28, wherein the step of depositing the adhesive coating comprises plasma enhanced chemical vapor deposition (PECVD), wherein the deposition temperature is between 50 and 100 degrees Celsius.

30) The method of claim 29, wherein the PECVD temperature is 55 degrees Celsius.

31) The method of claim 30, wherein the PECVD process includes depositing the a-SiN:H so that the a-SiN:H has a thickness of between 50 and 100 nanometers.

32) The method of claim 31, wherein the PECVD process includes depositing the a-SiN:H so that the a-SiN:H has a thickness of 50 nanometers.

33) The method of claim 32, wherein the step of depositing the top coating includes heating polyethylene to between 100 and 200 degrees Celsius and depositing the polyethylene onto the adhesive layer.

34) The method of claim 33, wherein the temperature for heating the polyethylene is 170 degrees Celsius.

35) The method of claim 34, including shaping the polyethylene so that the surface of the polyethylene has a parabolic contour.
